(19) United States
(12) Patent Application Publication
(10) Pub. No.: US 2003/0229736 A1
(43) Pub. Date: Dec. 11, 2003

(54) Portable read-write memory with USB interface

(76) Inventor: Hsuan-Ming Shih, Chung-Li City (TW)

Correspondence Address: TAI GUEN ENTERPRISE CO., LTD., P. O. Box No.6-57, Chung-Ho, Taipei, 235, TW

(21) Appl. No.: 10/163,517

(22) Filed: Jun. 7, 2002

(51) Int. Cl. G06F 13/12

(52) U.S. Cl. 710/62

(57) ABSTRACT

A portable Read-Write Memory with USB interface is disclosed. The portable Read-Write Memory includes an external housing and a control circuit within the housing. The control circuit includes USB interface, flash memory, CPU, and register, wherein the CPU completes address selection and modular conversion, and the ports thereof are connected to USB, flash memory, and register. In addition, the CPU port is also connected to IR module or emitting frequency identification module having sensing antenna.

### BACKGROUND OF THE INVENTION

(a) Field of the Invention

The present invention relates to a portable Read-Write Memory with USB interface, and in particular, to a Read-Write Memory having a large storage capacity and a high storage reliability and the memory provides instantaneous use on plug-in.

(b) Description of the Prior Art

In all recent available mobile storage device, the object of practically mobile has never been achieved. As a result of large volume of the memory which is not convenient in portability, for instance, the externally-mounted hard disc, externally-mounted engraving and recording device, ZIP, MO, etc. These devices provide larger storage capacity but they are insufficient mobility. If these devices are used as portable memory, for instance, soft disc, a large space within the specific utilized driving device will be taken up, and the energy exhaustion is great, and the noise is high. As the operation speed of the soft disc drive is slow, the storage space is small and the data storage is not reliable. Other than the unsafe characteristics of the magnetic medium as storage medium, and the soft disc is a portable product, physical damages are easily found. Therefore, practically the existing memory is not application and it is an object of the present invention to provide a portable Read-Write Memory with USB interface, which overcomes the above drawbacks.

### SUMMARY OF THE INVENTION

It is an object of the present invention to provide a portable Read-Write Memory with USB interface, wherein the memory has a large storage capacity, high reliability of storage, a volume which is convenient to carry along, and allows instantaneous use on plug-in, and the memory not only can integrate with an emitting-frequency Identification device or with a wireless receiving element to form externally-mounted communication interface for PC, and can be personal identification device.

A further object of the present invention is to provide a portable Read-Write Memory with USB interface which can protect the data in confidential, and can pass through physical switching to implement the management of the read-write of data.

Other objects and advantages of the present invention will become more apparent from the following description taken in conjunction with the accompanying drawing.

### BRIEF DESCRIPTION OF THE DRAWINGS

FIG. 1 shows a perspective view of a portable Read-Write Memory in accordance with the present invention.

FIG. 2 is schematic view of the basic circuit diagram of the portable Read-Write Memory in accordance with the present invention.

FIG. 3 shows the circuit diagram of the wireless receiving section of the portable Read-Write Memory in accordance with the present invention.

FIG. 4 is a circuit structure diagram of the wireless receiving section in accordance with the present invention.

### DETAILED DESCRIPTION OF THE PRESENT INVENTION

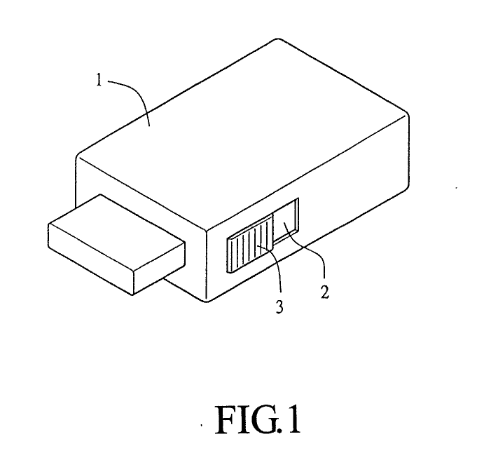

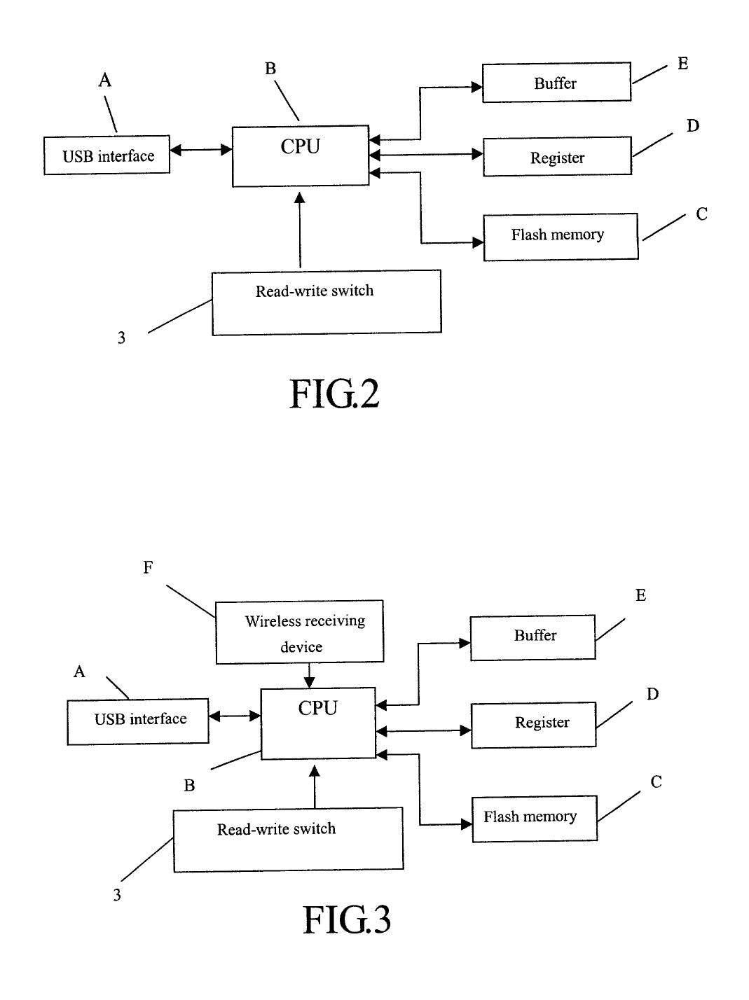

Referring to FIGS. 1, 2 and 3, there is shown a portable Read-Write Memory with USB interface, and the memory includes an externally mounted housing 1 and a control circuit within the housing 1. The control circuit includes USB interface A, CPU B, flash memory C, register D, and buffer E, wherein CPU B completes address selection and modular conversion, and the ports of the CPU B is connected to USB A, the flash memory C and the register D.

The external side of the housing 1 is provided with a window 2 having a Read-Write control switch 3 and one end of the control switch 3 is connected to the Read-Write control junction line of the CPU B port, and the other end is connected to ground.

The Read-Write control switch 3 is a sliding switch which slides along for the window 2 as a guiding slot, or is a press switch or a switch which can be triggered to the left and right. In addition, the CPU B is connected to memory disposed with electronic lock code number or with guiding program, and to wireless receiving device F.

As a device for mobile storage, the flash memory of the present invention is used as a storage medium and the capacity of storage is determined by the size of the flash memory.

User can moves a large capacity data or exchange data and the flash memories can be connected in series to increase the capacity of the flash memories.

The USB interface A is in communication with PC and it can be plugged in directly for utilization and can be used to show the advantages of mobile storage.

The device of the present invention is a data storage device, and the data transmission is performed via the two leads of DP, DN and the USB junction of the main board, and the data of the hard disc and the data within the flash memory are inter-transmitted to facilitate data portability.

The USB input voltage is DC 5V and the working voltage is 3.3V. Thus, the circuit employs circuit which convert 5V AC to 3.3V.

U1 is USB IC, and via DATA+, DATA− leads is connected to USB junction. It has 15 address lines, 2 sets of data lines, 32 I/O junctions, RD, WR leads to proceed to data read and write operation.

U3 is a flash memory, the inter-transmitted data between the hard discs can be stored therein. If power is cut off, the data still remains.

U4 is a buffer, having 15 address lines A0-A15, and 1 set of data line 101/108 and is used for temporary storage of data.

U6 is a memory for placing code number, and via the main SDA, SCL leads, the memory is connected to main IC and U6 is used to read and access the device description so as to recognize the type of device.

After the device is inserted into the USB junction of the main board, via Internet DN, DP, the data is transmitted to the main chip U1, 1C for the treatment. Data is read from serial EEPROM U6, and commands are reset simultaneously. After the device is reset, the device is at normal working status.

The Read-Write switch SW1 is connected to WP A2 of CPU and the control end is connected to high frequency so as to permit “Read-Write”, or via the resistance R3, it is connected to the ground, and only Read is possible.

When the system is reset, data transmission is initiated and the host computer will provide a command to open the disc-selection and to initiate the RD or WR control signals. Data from the hard disk, via address line selecting its address, and via data line transmitting data, is transmitted and is stored to U4 SRAM or U3 flash memory. The CMOS SRAM is used to provide a buffering function, and when power is cut off, data will be lost but the data within the flash memory will not. Thus, the final data will be placed in the U3 flash memory MEMORY for storage allowing portability when desired.

Based on the characteristics of the extended time of insertion the present device at the USB junction, the present memory can be incorporated with computer defense lock function. If the user has not inserted the present device, the PC cannot be operated or partial of the program or software is not execuble. The present device can prevent other user to enter the computer system without pennission and the computer utilization can be recorded, and all the action after the user has logged on will also be recorded.

The USB electronic disc is provided with antenna (receiving end) of the wireless device. The mounting of the antenna to the USB electronic disc increases the practicability of the USB electronic disc and reduces problems due to insufficient USB junction.

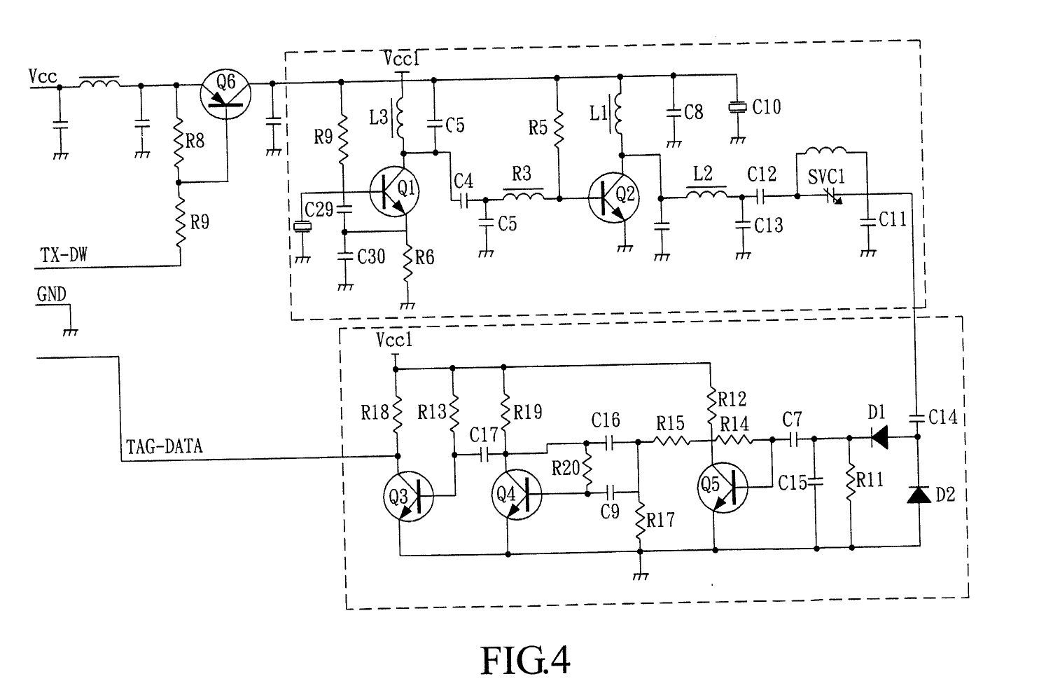

Referring to FIG. 4, the wireless device can be IR device, RF device and RFID device, and external data passes through TAG DATA wireless path, for instance sensing signal of the antenna, or IR receiving element, to the receiving unit. When the data enters the connection unit, it will transfer to the delivery unit and via the TX-PW leads of the delivery unit, the data is transmitted to CPU. CPU receives data via SDA, SCL leads and transmits data to PC via USB junction.

In the wireless devices, RF wireless transmission device and IR wireless transmission device are the major devices. Based on the wireless device used together with the present device, the transmission mode and transmission frequency can be determined. Among RF wireless devices, all products having receiving end gathered at the USB electronic disc can be employed, for instance, RFID receiving end.

When the present device is incorporated with emitting end function of RFID, the present device can be used to replace all the utilized TAG based on different door alarm system. The TAG, if in combination with other door alarm system, is provided by door alarm system supplier which is integrated into the device, or the PC is integrated with a RFID receiving end section, the present invention is used to identify the identity of PC end. Thus, with respect to mobile office or mobile storage, the present invention has a significant meaning. The mobile storage device not only can be utilized on PC, in everyday life, the present invention can be used as electronic identification certification center, such as door security system, car alarm system, etc.

In view of the above, the advantages of the present invention are as follows:

1. The present device is thin, light and small in size as that of a pen and provides large storage space and the stored data is safe and is not easily physically destroyed.

2. The present device can be used conveniently without opening the housing of the computer. Only a USB device interface is needed without isolated driver and disc, as a result no support system problem will occur.

3. The present device has great mobility and can be operated without operating system to achieve the object.

4. The storage data of the present device is reliable as the flash memory will not be easily physically damaged. User can move the data conveniently.

5. The present device provides confidential data protection on the electronic disc. User needs to login the correct code number and therefore the electronic will not be abused without authorization.

6. The present device allows PC electronic lock.

7. The present device is incorporated with emitting end section of RFID (TAG) and via the product (keyboard) of RFID receiving end, it provides a safe guard to the computer.

8. Company TAG can be incorporated into the present device to replace the existing identification card.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A portable Read-Write Memory with USB interface having an external housing and a control circuit therein, characterized in that the control circuit includes USB interface, flash memory, CPU, and register, wherein the CPU completes address selection and modular conversion, and the port of the CPU connects the USB, flash memory and register.

2. The portable Read-Write Memory with USB interface as set forth in claim 1,
wherein the control circuit further include Read-Write control switch, and one end thereof is connected to CPU port and the other end thereof is connected to high electrical frequency or ground.

3. The portable Read-Write Memory with USB interface as set forth in claim 1,
wherein the Read-Write control switch control section is located at the exterior of the housing.

4. The portable Read-Write Memory with USB interface as set forth in claim 2,
wherein the Read-Write control switch is a sliding switch slidable along the window being acted as a guiding slot, or is a press switch, or a switch which can move to the left and right.

5. The portable Read-Write Memory with USB interface as set forth in claim 1,
wherein the CPU is connected to a storage device having electronic locking code number or guide program.

6. The portable Read-Write Memory with USB interface as set forth in claim 1,
wherein the CPU port is connected to wireless receiving apparatus.

7. The portable Read-Write Memory with USB interface as set forth in claim 6,
wherein the wireless receiving device is a IR module or an emitting frequency identification module having sensing antenna.
